(19) United States
(12) Patent Application Publication
(10) Pub. No.: US 2003/0188271 A1
(43) Pub. Date: Oct. 2, 2003

(54) System and method for integrated circuit design

(75) Inventors: Wenjun Zhuang, Singapore (SG); Olivier Laurent Peyran, Singapore (SG); Zheng Zeng, Toronto (CA); Ping Bai, Singapore (SG)

Correspondence Address: Jphn P. White, Cooper & Dunham LLP, 1185 Avenue of the Americas, New York, NY, 10036, US

(73) Assignee: Institute of High Performance Computing

(21) Appl. No.: 10/261,235

(22) Filed: Sep. 30, 2002

(30) Foreign Application Priority Data
Apr. 2, 2002 (SG) 200201838-0

(51) Int. Cl. G06F 17/50

(52) U.S. Cl. 716/2; 716/8

(57) ABSTRACT

The invention relates to an IC chip-planning system and method to provide automatic creation and optimisation of chip-level design plan alternatives that can meet user-specific target chip area/design density, chip shape/aspect ratio, delay/timing closure, and/or congestion/routability objectives at each level of the design—architectural, RTL, gate, structural and physical levels. By combining global searching and local searching, a multi-objective optimisation process and a single-objective optimisation process, the invention can greatly reduce searching and optimisation time. Flexible system structure allows for generation of the optimised chip-planning solutions via an open optimisation train, a small optimisation loop, and/or a large optimisation loop.

With a function module to extract the topological relationship between blocks or gene structure from existing solutions whether from previous designs or manual designs, the invention may also successfully combine human experience and/or work with other EDA tools. A parallel system structure with redundancy elimination is preferably employed to attain high performance in the chip-planning. The invention has the potential to produce near optimal chip-planning solutions to meet the requirements for system-on-chip IC designs having more than 100 million gates and 1 GHz frequency.

### FIELD OF THE INVENTION

The present invention relates in general to automated design techniques for an integrated circuit (IC). More particularly, the invention relates to a system and method for automatic integrated circuit design to produce chip level planning which may be capable of meeting the requirements for design of deep sub-micron (DSM) ICs, as well as very deep, or even ultra deep sub-micron (VDSM/UDSM) ICs.

### BACKGROUND OF THE INVENTION

Rapid advances in silicon technology have created real potential for integrating entire systems on a single chip. The increasing use of consumer electronics products has plunged the designers of ICs into the ultra-fast pace of consumer markets.

For IC designers, each advance in manufacturing technology translates into an increased demand to incorporate more functionality into smaller, faster ICs. In turn, designers find themselves placing further burdens on electronic design automation (EDA) environments, which were developed in a far simpler era of technology and are now being stretched beyond their intended use. And with each advance in process technology, the gap broadens between conventional EDA tools and fabrication capabilities. With expectations of 100 million-gate ICs, designers are already facing problems in the move to system-on-chip design and are looking for new methods to handle these complex designs.

The silicon technology that enables system-on-a-chip (SoC) design demands that designers consider numerous effects. Perhaps most difficult is achieving timing closure, which depends heavily on the top-level interconnect modelling and delay/timing closure estimation. This problem is becoming particularly severe in deep-sub-micron (DSM) processes (0.25 micron and below) since the delay on interconnect can no longer be ignored because of its increased impact on performance, delay/timing closure, power and chip area/design density. Statistical wire load models that were sufficient in the past are largely inaccurate in the VDSM/UDSM era. Chip-level interblock wires must be accurately planned to minimise and guarantee the delay through this interconnection between blocks. Pin locations are also essential due to the impact on the interconnection length and routing paths and the timing budgets for each block.

This environment has a major effect on how designers design IC's, especially their design methodology. Traditional design flow is divided into logic/system design and physical design stages. In the logic/system design stage, delay/timing closure estimates are made by module/gate delays and estimating interconnect delays based on fanout of modules/gates roughly and statistically. Physical design is performed independently after logic/system design is completely finished. The real delay on the interconnection could be very different from previous estimation in the system design stage due to ignoring the particular interconnection in length, routing path, etc. As a result, a large number of iterations between logical/system and physical design need to occur. This situation is exacerbated if a higher operating frequency is applied. The long and large iterations between logical/system and physical designs often dominate the design schedules.

In order to develop a high performance system based on process technology lower than 0.18 micron, the physical implementation process must be more tightly integrated into the logical design process. Clearly, a new design flow is needed.

Hierarchical or block-based design methodologies, which are based on the traditional divide-and-conquer paradigm, are quickly being recognised as one of the primary mechanisms to realise large and complex multi-million-gate designs. It has a number of advantages. It permits the design to be broken into smaller, manageable pieces, each of which can then be designed in parallel by multiple teams spread across the globe. It is also well suited to early “what-if” explorations of alternative floor-plans in the search for the best results to meet the required design objectives. In addition, it provides early feedback into the feasibility of delay/timing closure, chip area/design density, congestion/routability and power constraints. It also enables re-use of firm, soft and hard intellectual-property (IP) blocks.

With the next-generation of EDA tools, early feedback will give front-end designers the opportunity to identify and prevent many chip-level physical design problems well before the traditional back-end physical design stage.

Block-based chip planning tools would desirably automatically create and optimise multiple chip plan alternatives that meet targets of delay/timing closure, chip area/design density, chip shape/aspect ratio, congestion/routability and power objectives at each level of design—architectural, RTL, and physical levels. They would automatically generate design plans quickly and accurately enough so designers can explore different alternatives throughout the design process and focus on just those configurations best able to meet overall chip objectives.

Designers could then perform “what-if” analyses to find the optimum configuration needed to meet design objectives for key performance parameters-2-including chip area/design density, chip shape/aspect ratio, delay/timing closure, congestion/routability and power consumption.

As the block implementation provides further details, chip-planning tools could update the chip plan and refine it. In fact, the same information used early in the design is carried through the process to be used later in design. For designers, the result is a robust development process that is able to reach design convergence and produce manufacturable designs more efficiently, more accurately and more predictably than possible with last-generation tools.

However, chip planning has been classified as an NP-complete problem. The inputs to the chip planning is a set of blocks that may be fixed blocks and/or flexible blocks; e.g. the area of each block, possible shapes of each block (aspect ratio), the number of terminals, electric parameters for each pin, the netlist and frequency for each net, and the path list. Chip planning needs to determine an appropriate shape for each block under the constraint of aspect ratio, assign the location for each block on a layout surface that will not overlap, determine the locations of pins on the boundary of the blocks and plan for the interconnection according to the netlist so as to meet the design specifications. The design specification will typically include chip area/design density, delay/timing closure that can be maximum delay or maximum difference between timing budget and real delay on the path, congestion or routability and power dissipation. It can be seen that chip planning is a multi-objective (such as chip area/design density, chip shape/aspect ratio, delay/timing closure, and congestion/routability) optimisation and multi-dimension (such as block shape, block location, block orientation and pin position) problem. The possible solutions can be numerous and may be distributed within a huge space.

Accordingly, it would clearly be desirable to develop a high performance chip-planning system that is able to find the near-optimal circuit design solutions efficiently.

A high performance chip-planning tool should desirably be able to perform the following functions:

(i) prototype or preview system designs in the system design stage. That is, applying the high performance chip planning, the system designer should be able to prototype or preview the designed system implementation on the silicon. This would be a drastic improvement that would overcome the gap between system design and chip design. The designer could verify or optimise the system designs within the requirements in DSM, VDSM or UDSM technology;

(ii) work as a DSM/VDSM/UDSM chip design manager. Following the hierarchical design methodology, the high performance chip-planning tool should be able to play a role as a chip design manager. Applying the high performance chip planning, the designer could globally optimise the chip designs and utilise the budget of timing and power dissipation. The chip planning would desirably also conduct all of the block design with global optimisation;

(iii) provide “on-line optimisation”. By solidifying the soft-block, the high performance chip planning could immediately take the results of designed blocks for further optimisation. All of the remaining soft-block could be immediately optimised in shape and pin assignment with the solidified blocks. It would be particularly useful for a chip designer to achieve success in first silicon for most DSM/VDSM chip design.

### SUMMARY OF THE INVENTION

To find near-optimal IC design solutions efficiently, the present invention provides a high performance chip-planning system and method that integrate advantages from different optimisation algorithms.

According to one aspect, the present invention provides a system for generating optimised chip-planning solutions, including: a dynamic parallel genetic algorithm (DPGA) module adapted to receive a plurality of input parameters and to generate first-phase chip-planning solutions based on global searching and a multi-objective optimisation process; and a linear programming (LP) module adapted to refine the first-phase chip-planning solutions based on local searching and a single-objective optimisation process to generate second-phase chip-planning solutions.

In a preferred embodiment of the invention, the LP module is adapted to remove redundancies in the first-phase chip-planning solutions from the DPGA module.

In a preferred embodiment of the invention, the input parameters for the DPGA module include design constraints and/or placement structures. The design constraints may contain flexible blocks and/or prefixed parameters. Preferably, the input parameters for the DPGA module include one or more of: chip area/design density; chip shape/aspect ratio; pin assignment; delay/timing closure; and congestion/routability.

In a preferred embodiment of the invention, the DPGA module generates the first-phase chip-planning solutions optimised in terms of chip area/design density, delay/timing closure and congestion/routability. Preferably, the LP module generates the second-phase chip-planning solutions optimised in terms of chip area/design density. However, the LP module is desirably able to converge to a set of target solutions through different optimisation paths.

In a preferred embodiment, the system of the invention includes at least one optimisation loop by means of which the second-phase chip-planning solutions may be further refined. The system of the invention preferably includes an evaluation module for evaluating the second-phase chip-planning solutions to determine whether or not the second-phase chip-planning solutions should be further refined, and if so, by which optimisation loop.

In a preferred embodiment, the system of the invention includes a critical path/block analysis module adapted to provide further optimisation rules to the LP module to refine the second-phase chip-planning solutions if further optimisation is needed. The LP, evaluation and critical path/block analysis modules together form a small optimisation loop.

In a preferred embodiment, the system of the invention includes a structure extraction module adapted to extract solutions from other EDA tools or manual chip-planning and introduce them into the system. The structure extraction module preferably extracts topological relationships between blocks or gene structures from the second-phase chip-planning solutions and re-directing them into the DPGA module if further optimisation is needed. The DPGA, LP, evaluation and structure extraction modules together form a large optimisation loop. The structure extraction module preferably converts the second-phase chip-planning solutions—to data with DPGA evolution format for the DPGA module if major-optimisation is needed. Alternatively, it may convert solutions created by other EDA tools, or solutions created and/or modified by human knowledge or experience, for combination with the automated chip-planning system.

In a preferred embodiment, the system of the invention includes a dynamic controller for automatically controlling the optimisation process, wherein the dynamic controller is adapted to:

follow an open optimisation train if and only if for the top 20% best solutions in the result set, design targets have been met after the result evaluation, or the run time is over a predefined parameter of runtime;

follow the small optimisation loop if and only if for the top 20% best solutions in the result set, chip ratio and chip area/design density have met the design targets and the error of delay/time closure and congestion/routability are within a predefined region; and

follow the large optimisation loop if and only if conditions of following open optimisation train and small optimisation loop cannot be satisfied.

Thus, by combining global searching and local searching, a multi-objective optimisation process and a single-objective optimisation process, the present invention has the potential to achieve a performance level sufficient to meet the requirements for system-on-chip design, with more than 100 million-gate IC. Thus, the invention is an IC chip-planing system that enables automatic creation and optimisation of chip-level design plan alternatives that can meet user-specific targets of chip area/design density, chip shape/aspect ratio, delay/timing closure, and congestion/routability objectives at each level of the design. With a special function module, the invention can be used to further optimise an existing chip planning solution through a structure extraction and input procedure. Hence its potential to produce the near-optimal solutions and to merge or combine advantages from other EDA tools and even human experience into the system to reach the best optimisation results.

The DPGA module can be any multi-objective and global searching optimisation algorithm. The LP module can be any single-target and local searching optimisation algorithm. The system of the invention is thus typically embodied as a computer software system, with the DPGA and LP modules constituted by suitable algorithms in parts of the software code.

According to another aspect, the invention provides a method of creating optimised chip-planning solutions for IC design, including the steps of:

providing a plurality of input parameters, such as design constraints and/or placement structures for the IC design;

executing a global searching and multi-objective optimisation process to generate first-phase chip-planning solutions; and

executing a local searching and single-objective optimisation process to refine the first-phase chip-planning solutions and generate second-phase chip-planning solutions.

In a preferred embodiment of the invention, the global searching and multi-objective optimisation process is executed in a dynamic parallel genetic algorithm (DPGA) module, and the local searching and single-objective optimisation process is executed in a linear programming (LP) module.

In a preferred embodiment of the invention, the method includes the step of evaluating the second-phase chip-planning solutions to determine whether or not they should be further refined, the evaluating step being performed by an evaluation module. Preferably, the method includes the step of further refining the second-phase chip-planning solutions using at least one optimisation loop.

In a preferred embodiment of the invention, the method includes:

providing a small optimisation loop including a critical path/block analysis module to provide further optimisation rules to the LP module to refine the second-phase chip-planning solutions if further optimisation is needed; the LP module, evaluation module and critical path/block analysis module together forming the small optimisation loop; and

providing a large optimisation loop including a structure extraction module to extract topological relationships between blocks or gene structures from the second-phase chip-planning solutions and re-direct them to the DPGA module if further optimisation is needed; the DPGA, LP, evaluation and structure extraction modules together forming the large optimisation loop.

In a preferred embodiment of the invention, the method includes: dynamically selecting an open optimisation train, or the small optimisation loop, or the large optimisation loop to reach the optimised target solutions in the shortest time.

That is, the method includes generating final chip-planning solutions by dynamically choosing:

(i) to output the second-phase chip-planning solutions directly as the final chip-planning solutions if the design requirements are met after evaluating chip area/design density, chip shape/aspect ratio, delay/timing closure and congestion/routability; or

(ii) to generate the final chip-planning solutions through the small optimisation loop if minor optimisation is needed for the second-phase chip-planning solutions after span or gradient analyses; or

(iii) to generate the final chip-planning solutions through the large optimisation loop if major optimisation is needed for the second-phase chip-planning solutions.

Generating final chip-planning solutions by the small optimisation loop preferably includes analysing the critical path and blocks in terms of delay/timing closure and congestion/routability, selecting a sub-structure or constraints between sensitive blocks, optimising the second-phase chip-planning solutions according to the modified structure with a local searching technique and single-objective optimisation process LP to generate a new second-phase chip-planning solution, and evaluating the new second-phase chip-planning solutions to determine whether to output them as the final chip-planning solutions or optimise them further.

Generating final chip-planning solutions by the large optimisation loop preferably includes extracting the topological characteristics or gene structures from the second-phase chip-planning solutions and converting them into data with DPGA evolution format, creating new first-phase chip-planning solutions from the data with the global searching technique and multi-objective optimisation process of the DPGA module, generating new second-phase chip-planning solutions by further optimising the new first-phase chip-planning solutions with the local searching technique and single-objective optimisation process of the LP module, and evaluating the new second-phase solutions to determine whether to output them as the final chip-planning solutions or optimise them further.

In a preferred embodiment, the method of the invention includes merging other chip planing/floorplan/placement EDA tools or/and human knowledge with the invention to produce near-optimal chip-planning solutions including extracting the characteristics or gene structures from the solutions generated by other chip planing/floorplan/placement EDA tools or manually, creating second-phase chip-planning solutions through merging global searching and local searching, multi-objective optimisation process and single-objective optimisation process together, and generating final chip-planning solutions by dynamically choosing the optimisation loops.

A non-balanced searching strategy is preferably employed in the combination of the global, multi-objective optimisation process and the local, single objective optimisation process.

In the DPGA module, ie the global and multi-objective searching module: a newly accepted solution k is accepted if it satisfies following conditions:

in the present population of solutions, there exists solution (l);

Area (k)≦Area (l)*(1+β), β>0; And Delay (k)<Delay (l); Congestion (k)≦Congestion (l); Ratio (min)≦Ratio (k)≦Ratio (max); or

Area (k)<Area (l)*(1+β), β>0; And Delay (k)≦Delay (l); Congestion (k)<Congestion (l), Ratio (min)≦Ratio (k)≦Ratio (max); or

Area (k)<Area (l); And Delay (k)≦Delay (l); Congestion (k)≦Congestion (l); Ratio (min)≦Ratio (k)≦Ratio (max);

In a preferred embodiment of the invention, a parallel system structure with redundancy elimination is applied for reaching higher performance in the chip planning. With distributed computing technology, data (solutions) slicing, redundancy elimination and workload balancing, the design performance of the present DSM/VDSM chip planning system can be improved upon.

A parallel structure is implemented through distributing all solutions in a selected solution set to all processors equally in workload. So, the data (solutions) slicing technology is applied for the purpose of ‘parallelisation’. The parallel structure further includes redundancy elimination in two interfaces between the DPGA and LP modules, and before the procedure of extracting the solution structure.

A multi LP or the local and single objective search engine, evaluation, critical and sensitivity analysis and gene extraction modules are designed to process the design in a distributed way.

The above and further features and advantages of the present invention will be more fully appreciated from the following detailed description of preferred embodiments of the invention with reference to the accompanying drawings.

### BRIEF DESCRIPTION OF THE DRAWINGS

FIG. 1 is a structure diagram of a chip planning system according to an embodiment of the present invention.

FIGS. 2A to 2D illustrate the best results of Ami33F and Ami49F from DPGA and LP (FIG. 2A shows the Ami33 result after DPGA; FIG. 2B shows the best result of Ami33 after LP; FIG. 2C shows the original result of Ami49F; and FIG. 2D shows the best result of Ami49F after LP). The results demonstrate a significant improvement in chip area/design density through the merged searching.

FIGS. 3A and 3B illustrate the statistic results to compare the results of DP with their DPGA solutions for 200 Ami33F test samples and 200 Ami49F test samples.

FIGS. 4A and 4B show the statistic results to compare the structure extraction results with their original solutions for 500 Ami33F test samples and 500 Ami49F test samples.

### DETAILED DESCRIPTION OF THE INVENTION

The primary aim of the present invention is to be able to generate optimised chip-planning solutions automatically and with high performance from the design constraints to meet chip area/design density, chip shape/aspect ratio, delay/timing closure, and congestion/routability objectives specified at each level of the design, such as architectural, RTL, Gate, structural and physical levels. Advantageously, the invention can also be used to further optimise any chip-level design plans or placement generated by other EDA tools or manually, and to generate the near-optimal solutions.

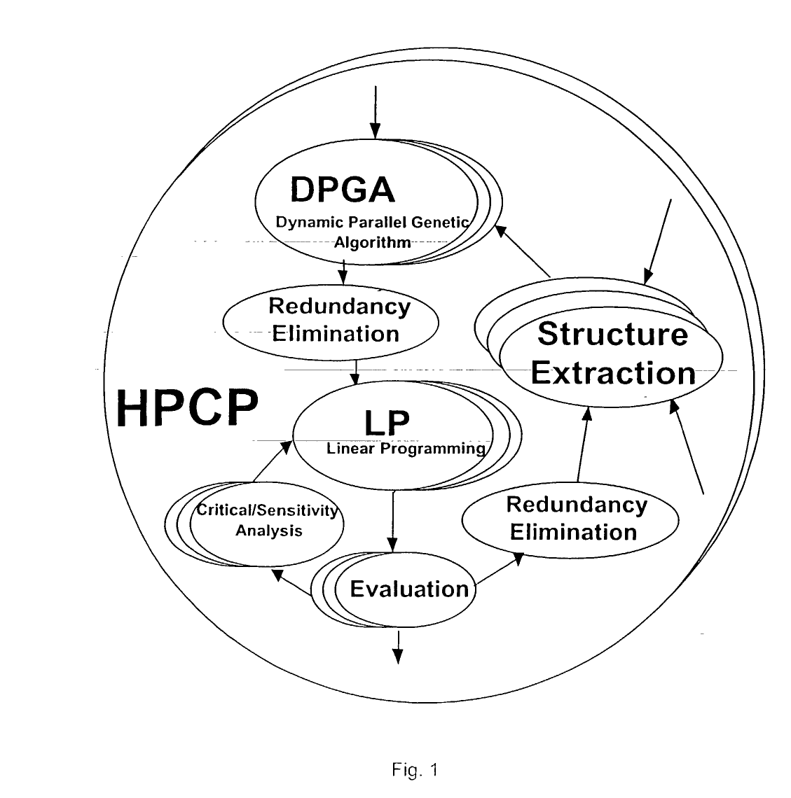

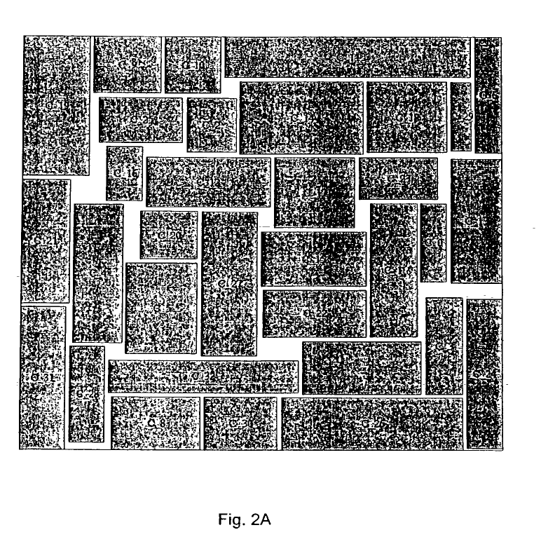

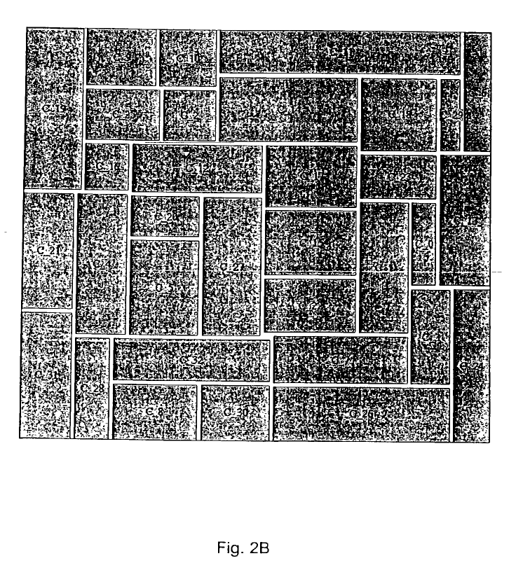

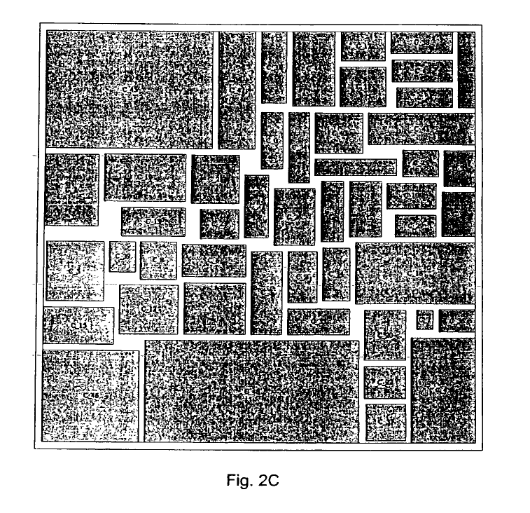

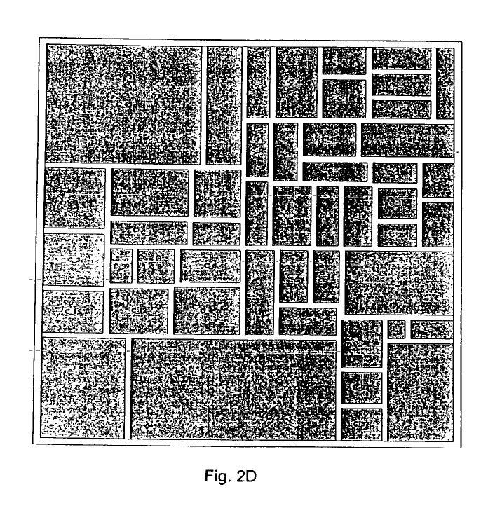

FIG. 1 is a structure diagram of a high performance chip planning system according to an embodiment of the present invention. The DPGA module is used to generate first-phase chip-planning solutions with global searching and multi-objective optimisation process. The LP module is used to find out further optimised solutions in a reduced searching space with a local searching and—single-objective optimisation method.

The DPGA module receives a set of input parameters including number of fixed blocks or/and flexible blocks, the area of each block, aspect ratio for each flexible block, the number of I/O pins and block pins, electronic parameters for each pin (internal delay, capacitance and resistance), the netlist and frequency for each net, the path list, the technology parameters and system control parameters.

The DPGA module uses a genetic algorithm to search the entire global solution space with speckle model and parallel search technique to determine an appropriate shape for each flexible block under constraint of aspect ratio, assign the location for each block on a layout surface without overlap, determine the locations of pins on the boundary of the blocks and plan for the interconnection according to the netlist so as to meet the chip area/design density, chip shape/aspect ratio, delay/timing closure and congestion/routability requirements.

Given enough computation time, the DPGA module could find near-optimal solutions for the chip problem. Compared with other global search and multi-objective optimisation algorithms, such as simulated anneal or static sequential genetic algorithm, the DPGA module is very fast (hundred times faster) in terms of convergence speed. However, it is still not fast enough to meet the 100 million gates SoC design requirements. Moreover, this challenge to performance is only likely to become even more serious with future advances in IC technology.

Generally speaking, local searching is faster than global searching and single-objective optimisation is faster than multi-objective optimisation. In particular, the DPGA module, a global and multi-objective searching engine, converges very fast at the beginning of searching and slows down gradually as it approaches the optimal target. This makes it possible to reduce the total searching time by merging or combining the DPGA module (in an early stage) with certain local searching and single-objective optimisation methods (for further local optimisation) for the purpose of further improving quality and performance.

The system of the present invention merges or combines the DPGA and LP modules. That is, it combines global and local searching methods, a multi-objective optimisation process and a single-objective optimisation process, to speed up the convergence time. The DPGA module searches all the possibilities (whole searching space) in terms of optimal chip area/design density; optimal delay/timing closure and optimal congestion/routability and tries to find all the local spaces where optimal solutions are likely to be located. This can be done very quickly since it reduces the searching space but does not calculate the optimisation results. Then LP removes the redundant structures from the first-phase chip-planning solutions and searches each local space to find the best solutions in terms of chip area/design density only. It is also very fast because it is a local search with only one optimisation target (ie chip area/design density). In other words, the DPGA module is used to generate coarse chip-planning solutions and the LP module is used to tune the coarse solutions to generate finer chip-planning solutions.

A non-balanced search in the DPGA module ensures delay/timing closure and congestion/routability have a chance to be optimised with the chip area/design density in whole optimisation procedure. The DPGA module generates chip-planning solutions optimised in terms of chip area/design density, chip shape/aspect ratio, delay/timing closure and congestion/routability. The LP module optimises the solutions in terms of chip area/design density only. The changes in delay/time closure and congestion/routability can be ignored in this stage due to maintenance of the existing chip structure.

By modifying selected sub-structure or constraints between some sensitive blocks in delay/timing closure or congestion/routability, the delay/timing closure or congestion/routability may be changed accordingly. Therefore, the LP module has been specially developed with some evaluation and sensitivity analysis modules for a dynamic optimisation purpose in delay/time closure and congestion/routability.

The evaluation module is designed to determine whether or not the second-phase chip-planning solutions from the LP module need to be further optimised or refined. If further refinement of the second-phase solutions is required, the pin assignment delay/timing closure and congestion/routability are calculated again. If chip area/design density, chip shape/aspect ratio, delay/time closure and congestion/routability all meet the design budgets, the solutions will be output as final solutions right away. If any of them does not meet the requirements, span/gradient analysis will be conducted to determine whether the solutions should be further optimised through the small optimisation loop or the large optimisation loop.

The small optimisation loop includes the critical path & block analysis module, LP module and evaluation module. The LP module is the optimisation engine that is used to optimise the solutions in chip area/design density. The critical path & block analysis module is to locate critical paths and critical blocks in terms of delay/timing closure or congestion/routability. By conducting sensitivity analyses for the critical paths and blocks, the module can produce modification of constraints dynamically for the LP module. With the changed constraints, delay/time closure and congestion/routability could be improved during the chip area/design density optimisation in the LP module.

The large optimisation loop includes structure extraction module, the DPGA, LP and evaluation modules. Even though the second-phase chip-planning solutions from the LP module may not meet the requirements, they are optimised results to some degree. Starting from these results, acquiring the final results will be faster than starting from the original inputs according to genetic algorithm theory. The DPGA module is a type of genetic algorithm by nature. The second-phase chip-planning solutions are optimised through LP modules, so the performance of the new solutions will be surely better.

A dynamic control is provided for automatically controlling the optimisation processes by: (i) an open optimisation train with DPGA and LP, or (ii) an additional small optimisation loop; and/or (iii) an additional large optimisation loop, including extracting the gene structure based on the quality and performance that have been attained after evaluation of the obtained results.

The main objective of structure extraction module is to extract the topological relationship between blocks or gene structure from chip-planning, floorplan or placement solutions (whether they come from a previous design, other EDA tools, or manual design) and convert them into a kind of data with a format (gene structure) that the DPGA module can accept. The characteristics extracted include the structure relationship between blocks, aspect ratio for each flexible block, and orientation of each block. The format is the DPGA evolution format that is used in the DPGA module. So, the extracted structure could be input into the DPGA module for further optimisation.

To implement the large optimisation loop, the DPGA module is designed to be able to receive either the design constraints or chip-planning solutions in DPGA evolution format

FIG. 1 has shown that the system creates the near-optimal chip-planning solutions from design constraints according to an embodiment of the present invention. After receiving the design constraints, the DPGA module creates the initial gene structure. It then generates the first-phase chip-planning solutions with multi-objective evolutions. After the redundant structures are removed from the first-phase solutions, the LP module further optimises each of the first-phase chip-planning solutions in terms of chip area/design density within the local searching space and produces the second-phase solutions. Then pin assignment is performed and delay/timing closure and congestion/routability are estimated. By analysing the span or gradient, it can be decided whether or not the second-phase chip-planning solutions need to be optimised through the small optimisation loop. If need be, the critical paths and blocks are identified and delay/timing closure and congestion/routability sensitivity is analysed to set the optimisation parameters. The LP module then optimises the second-phase chip-planning solutions and generates the new second-phase chip-planning solutions according to the parameters. If not, the chip area/design density, delay/timing closure and congestion/routability are evaluated. If all of them meet the design requirements, the second-phase chip-planning solutions are output as the final solutions. Otherwise, the second-phase chip-planning solutions will be optimised through the large optimization loop.

The structure extraction module first extracts the characteristics or gene structure from the second-phase chip-planning solutions and then converts them into DPGA evolution format data that the DPGA module can accept. By passing the DPGA evolution format data to the DPGA module, the second-phase chip-planning solutions can be optimised again by the DPGA and LP modules and further optimised chip-planning solutions can be obtained.

The design of system-on-chip ICs with more than 100 million gates and a frequency of more than 1 Gigahertz is so complex that no previous EDA tool has been capable of it. There are quite a number of EDA tools from different EDA developers, and each of them has its own advantages. Moreover, for designing such complex systems, human experience can also play a very important role. In the task of finding near-optimal chip-planning solutions efficiently, it would be very helpful if the merits of other EDA tools and human experience could be used.

The present invention provides a means of merging human experience and other EDA tools with chip-planning system of the invention. FIG. 1 also shows that the system generates near-optimal chip-planning solutions by optimising the floorplan or placement solutions created by other EDA tools or manually according to an embodiment of the present invention. The flow is similar to that for input of design constraints. The difference is that the floorplan or placement solutions cannot be direct inputs to the DPGA module. Instead, they are inputs to the structure extraction module. After conversion to DPGA evolution format data, the solutions can be optimised through the DPGA and LP modules and generate final near-optimal solutions.

With the progress in IC technology and the complexity of the problem in DSM/VDSM chip planning, the performance requirements are an increasingly serious issue for chip designers and EDA system developers. To meet the requirements in design performance, a parallel system structure with redundancy elimination is applied for reaching higher performance standards of chip planning with the present invention.

The redundancy elimination technology is a pre-processing module for LP or gene extraction. The module is designed to determine a selected set of solutions from all results generated by previous design stages. All results of poor quality are discarded from the selected set of solutions. Also, only one result is selected from all acceptable solutions with same structure and kept in the selected set of solutions. The technology keeps all of the best results in chip area/design density, or delay/timing closure, or congestion/routability in the selected set of solutions. The technology improves the design performance without loosing any opportunity to obtain the optimisation result.

With distributed computing technology, data slicing could be applied for parallel computing purposes. So, after the selected set of solutions are assigned as several subsets of solutions to individual processors with an equal workload, a multiplex of modules functioning in LP as the local and single objective search engine, evaluation, critical and sensitivity analysis and gene extraction are designed to process the designs in distributed way.

Taking the advantage from data slicing, parallel computing, redundancy elimination and workload balancing, the performance of the DSM/VDSM chip planning system of the invention may be improved upon.

Simulated Results

Some simulation has been conducted to show the performance of merging global searching and local searching, multi-objective optimisation process and single-objective optimization process. In all of the testing, the test data are from the University of California, Berkeley, USA.

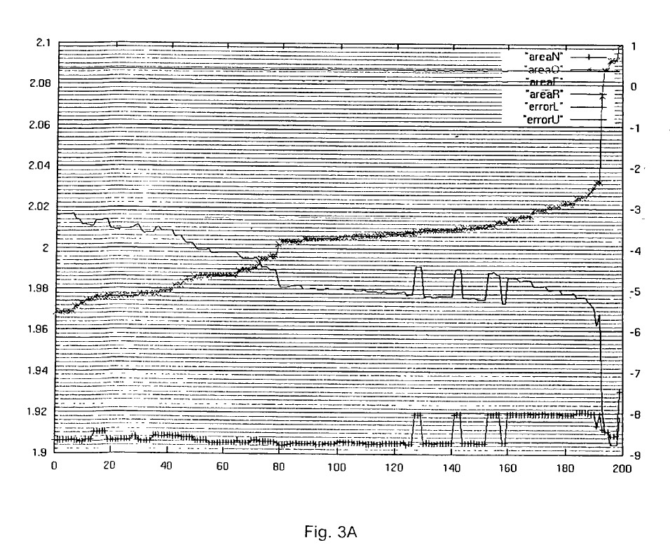

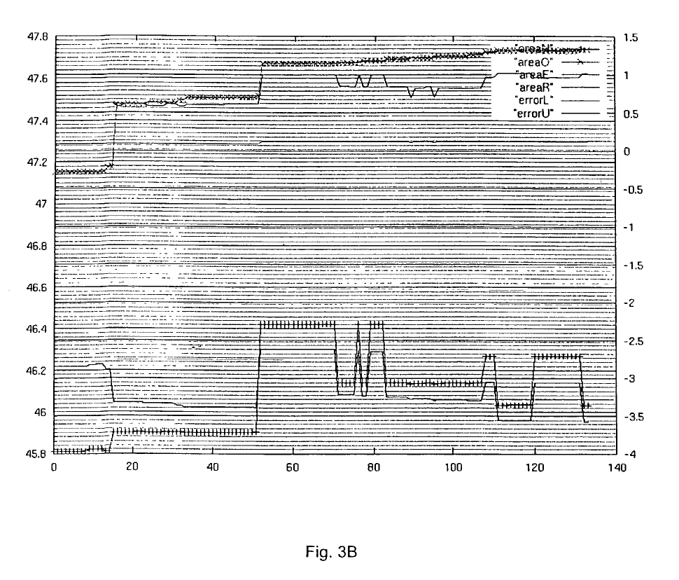

Benchmark—33 blocks have been used to evaluate the performance of the system of the invention. The DPGA module operates for 20 hours to generate 200 first-phase chip-planning solutions with global searching and a multi-objective optimisation process. The LP module then spends a few minutes to optimise the 200 first-phase chip-planning solutions in terms of chip area/design density and generates 200 second-phase chip-planning solutions. The chip area/design density of each solution before and after LP is shown in FIGS. 3A and 3B. The chip area has been reduced in the range of 1% to 6%.

The same benchmark is again input into the system of the invention, but this time the DPGA module operates only 1 hour to generate 200 first-phase chip-planning solutions with global searching and multi-objective optimisation process. The LP module then spends a few minutes to optimise the 200 first-phase chip-planning solutions in terms of chip area and generates 200 second-phase solutions. The chip area of each solution before and after LP is also shown in FIGS. 3A and 3B.

The results show that the chip area is reduced quite a lot after LP. Moreover, the chip area for solutions from the DPGA module in 1 hour plus LP in a few minutes is better than the chip area for solutions from the DPGA module alone in 20 hours. In other words, by merging global searching and local searching, a multi-objective optimisation process and a single-objective optimisation process, the optimisation speed can increase more than 10 times while the performance in terms of chip area is also improved compared with just DPGA optimisation alone.

The test results also show that the methods of merging global searching and local searching, multi-objective optimisation process and single-objective optimisation process is feasible and potential in quality and performance improvement.

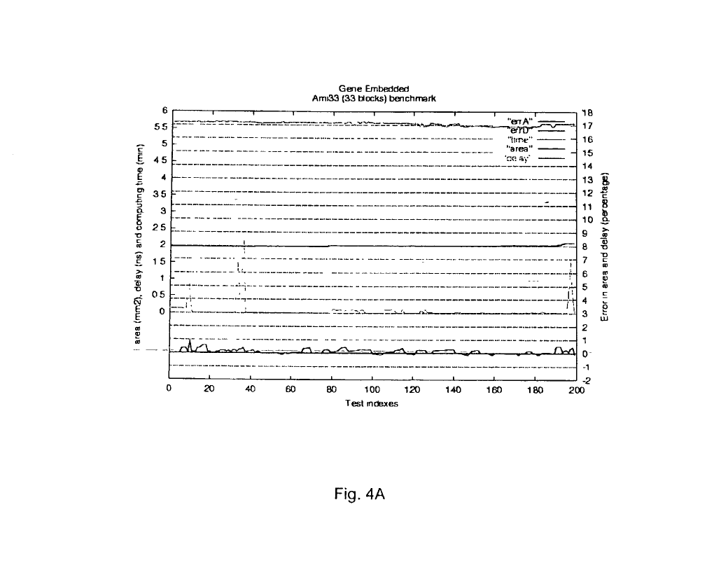

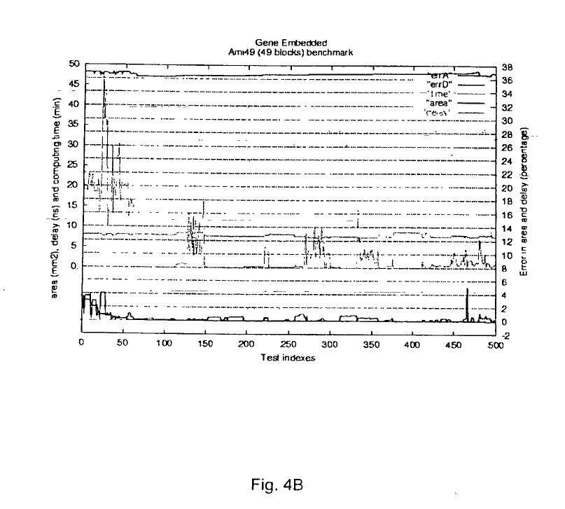

Over 700 test results have shown (in FIGS. 4A and 4B) that after a gene structure extraction over 95% results can keep their original structure for further optimisation.

For Ami33F, there are 200 test samples automatically created by the DPGA module. All of the results reformed from extracted gene structure have 100% equivalent area with the original solution. The delay of results include errors of between −0.5% and 0.7% of the original solution. In view of computation time for the gene structure extraction, for the 200 test samples, one requires 45 s computation on SUN E10000K, another requires 42 s. 99% of extraction operations require a computation time below 15 s, and 94% of the extraction operations need a computation time below 10 s on a 333 MHz Ultra Sparc processor with 384 Mbytes of memory.

For Ami49, there are 500 test samples automatically created by the DPGA module. 90% of the results are equivalent to the original in chip area, 96% have less than 0.5% increase in chip area, and 99% have less than a 2% increase in chip area. Only one result had a 2.7% increase in chip area. In delay, most results have less than 0.5-1% increase. Only one result had a surprisingly large increase in delay of 5%.

It was also demonstrated that a system with gene structure adoption/extraction and re-direction back into the DPGA module for the purpose of merging human experience and/or results from other EDA tools with the chip planning system is feasible.

Finally it is to be understood that various alterations and/or additions may be introduced into the particular construction and arrangement of parts described herein without departing from the spirit or ambit of the invention as defined in the following claims.

1. A system for generating optimised chip-planning solutions, including:
a dynamic parallel genetic algorithm (DPGA) module adapted to receive a plurality of input parameters and to generate first-phase chip-planning solutions based on global searching and a multi-objective optimisation process; and
a linear programming (LP) module adapted to refine the first-phase chip-planning solutions based on local searching and a single-objective optimisation process to generate second-phase chip-planning solutions.

2. A system according to claim 1, including at least one optimisation loop by means of which the second-phase chip-planning solutions may be further refined.

3. A system according to claim 2, including: an evaluation module for evaluating said second-phase chip-planning solutions to determine whether or not said second-phase chip-planning solutions should be further refined, and if so, by which optimisation loop.

4. A system according to claim 3, including: a critical path/block analysis module adapted to provide further optimisation rules to the LP module to refine said second-phase chip-planning solutions if further optimisation is needed;
whereby the LP, evaluation and critical path/block analysis modules together form a small optimisation loop.

5. A system according to claim 4, including: a structure extraction module adapted to extract solutions from other EDA tools or manual chip-planning and introduce them into the system.

6. A system according to claim 5, wherein the structure extraction module also extracts topological relationships between blocks or gene structures from the second-phase chip-planning solutions and re-directs them into the DPGA module if further optimisation is needed;
whereby the DPGA, LP, evaluation module and structure extraction module together form a large optimisation loop.

7. A system according to claim 6, further including: a dynamic controller for automatically controlling the optimisation process, wherein the dynamic controller is adapted to:
follow an open optimisation train if and only if for the top 20% best solutions in the result set, design targets have been met after the result evaluation, or the run time is over a predefined parameter of runtime;
follow the small optimisation loop if and only if for the top 20% best solutions in the result set, chip ratio and chip area/design density have met the design targets and the error of delay/time closure and congestion/routability are within a predefined region; and
follow the large optimisation loop if and only if conditions of following open optimisation train and small optimisation loop cannot be satisfied.

8. A system according to claim 1, wherein the LP module is adapted to remove redundancies in the first-phase chip-planning solutions from the DPGA module.

9. A system according to claim 1, wherein the input parameters for the DPGA module include design constraints and/or placement structures.

10. A system according to claim 9, wherein the design constraints contain flexible blocks and/or pre-fixed parameters.

11. A system according to claim 9, wherein the input parameters for the DPGA module include one or more of:
chip area/design density; chip shape/aspect ratio; pin assignment; delay/timing closure; and congestion/routability.

12. A system according to claim 11, wherein the DPGA module generates the first-phase chip-planning solutions optimised in terms of chip area/design density, delay/timing closure and congestion/routability.

13. A system according to claim 12, wherein the LP module generates the second-phase chip-planning solutions optimised in terms of chip area/design density.

14. A system according to claim 1, wherein the LP module is able to converge to a set of target solutions through different optimisation paths.

15. A system according to claim 3, wherein the evaluation module is adapted to re-conduct pin assignment and optimisation.

16. A system according to claim 3, wherein the evaluation module is adapted to conduct an evaluation with respect to chip shape/aspect ratio, delay/time closure and/or congestion/routability.

17. A system according to claim 3, wherein the evaluation module is adapted to conduct span or gradient analysis.

18. A system according to claim 4, wherein the critical path/block analysis module is adapted to identify circuit critical paths and/or blocks.

19. A system according to claim 4, wherein the critical path/block analysis module is adapted to analyse the delay/time closure and congestion/routability sensitivity.

20. A system according to claim 4, wherein the critical path/block analysis module is adapted to determine the modified sub-structure or constraints between selected blocks for the LP module in said small optimisation loop.

21. A system according to claim 6, wherein the structure extraction module is adapted to extract the characteristics or gene structure from chip-planning solutions, floorplan solutions or placement solutions.

22. A system according to claim 6, wherein the structure extraction module is adapted to convert said extracted characteristics or gene structure to data with DPGA evolution format.

23. A method of creating optimised chip-planning solutions, including the steps of:
providing a plurality of input parameters for IC design;
executing a global searching and multi-objective optimisation process to generate first-phase chip-planning solutions; and
executing a local searching and single-objective optimisation process to refine the first-phase chip-planning solutions and generate second-phase chip-planning solutions.

24. A method according to claim 23, wherein the global searching and multi-objective optimisation process is executed in a dynamic parallel genetic algorithm (DPGA) module, and wherein the local searching and single-objective optimisation process is executed in a linear programming (LP) module.

25. A method according to claim 24, including the step of evaluating said second-phase chip-planning solutions to determine whether or not they should be further refined, said evaluating step being performed by an evaluation module.

26. A method according to claim 25, including the step of further refining the second-phase chip-planning solutions using at least one optimisation loop.

27. A method according to claim 26, including the step of:
providing a small optimisation loop including a critical path/block analysis module to provide further optimisation rules to the LP module to refine said second-phase chip-planning solutions if further optimisation is needed; said LP module, evaluation module and critical path/block analysis module together forming the small optimisation loop; and
providing a large optimisation loop including a structure extraction module to extract topological relationships between blocks or gene structures from the second-phase chip-planning solutions and re-direct them to the DPGA module if further optimisation is needed; said DPGA, LP, evaluation and structure extraction modules together forming the large optimisation loop.

28. A method according to claim 27, including the step of:
dynamically selecting an open optimisation train, or said small optimisation loop, or said large optimisation loop to reach the optimised target solutions in the shortest time.

29. A method according to claim 28, wherein said step of dynamically selecting includes:
following the open optimisation train if and only if for the top 20% best solutions in the result set, design targets have been met after the result evaluation, or the run time is over a predefined parameter of run-time;
following the small optimisation loop if and only If for the top 20% best solutions in the result set, chip ratio and chip area/design density have met the design targets and the error of delay/time closure and congestion/routability are within a predefined region;
following the large optimisation loop If and only if conditions of following open optimisation train and small optimisation loop cannot be satisfied.

30. A method according to claim 28, including selecting solutions for said small optimisation loop by span or gradient analyses.

31. A method according to claim 28, including deciding the final solutions from said large optimisation loop by chip area/design density, chip shape/aspect ratio, delay/timing closure and/or congestion/routability evaluation.

32. A method according to claim 28, including assigning/optimising pin locations and estimating delay/timing closure and congestion/routability.

33. A method according to claim 28, including selecting sub-structure or constraints between sensitive blocks for said small optimisation loop.

34. A method according to claim 28, including extracting characteristics or gene structure from various solutions, said various solutions including said second-phase chip-planning solutions, previous chip-plan solutions and/or placement solutions generated manually or by other EDA tools.

35. A method according to claim 34, including converting said extracted characteristics or gene structure to data with said DPGA evolution format.

36. A method according to claim 23, further including providing non-balanced searching to optimise chip area/design density, chips shape/aspect ratio, delay/timing closure and congestion/routability.

37. A method according to claim 31, further including selecting sub-structure or constraints between sensitive blocks for LP to produce optimisation in delay/timing closure and congestion/routability within said small optimisation loop.

38. A method according to claim 27, including the step of:
incorporating other chip planing tools, such as electronic data automation (EDA) tools, or/and human experience into optimisation processes to reach the best optimisation results.

39. A system for generating optimised chip-planning solutions, including:
a dynamic parallel genetic algorithm (DPGA) module adapted to receive a plurality of input parameters and to generate first-phase chip-planning solutions based on global searching and a multi-objective optimisation process;
a linear programming (LP) module adapted to refine the first-phase chip-planning solutions based on local searching and a single-objective optimisation process to generate second-phase chip-planning solutions;
at least one optimisation loop by means of which the second-phase chip-planning solutions may be further refined;
an evaluation module for evaluating said second-phase chip-planning solutions to determine whether or not said second-phase chip-planning solutions should be further refined, and if so, by which optimisation loop; and
a structure extraction module adapted to extract solutions from other EDA tools or manual chip-planning and introduce them into the system.

40. A system according to claim 39, including: a critical path/block analysis module adapted to provide further optimisation rules to the LP module to refine said second-phase chip-planning solutions if further optimisation is needed;
whereby the LP, evaluation and critical path/block analysis modules together form a small optimisation loop.

41. A system according to claim 39, wherein the structure extraction module also extracts topological relationships between blocks or gene structures from the second-phase chip-planning solutions and re-directs them into the DPGA module if further optimisation is needed;
whereby the DPGA, LP, evaluation module and structure extraction module together form a large optimisation loop.

42. A method of creating optimised chip-planning solutions, including the steps of:
providing a plurality of input parameters for IC design;
executing a global searching and multi-objective optimisation process in a dynamic parallel genetic algorithm (DPGA) module to generate first-phase chip-planning solutions;
executing a local searching and single-objective optimisation process in a linear programming (LP) module to refine the first-phase chip-planning solutions and generate second-phase chip-planning solutions;
evaluating said second-phase chip-planning solutions to determine whether or not they should be further refined, said evaluating step being performed by an evaluation module;
providing a critical path/block analysis module to provide further optimisation rules to the LP module to refine said second-phase chip-planning solutions if further optimisation is needed; said LP module, evaluation module and critical path/block analysis module together forming a small optimisation loop;
providing a structure extraction module to extract solutions from other EDA tools or manual chip-planning or to extract topological relationships between blocks or gene structures from the second-phase chip-planning solutions and re-direct them to the DPGA module if further optimisation is needed; said DPGA, LP, evaluation and structure extraction modules together forming a large optimisation loop; and
if necessary, further refining the second-phase chip-planning solutions using at least one of said optimisation loops.
